(19) United States
(12) Patent Application Publication
(10) Pub. No.: US 2017/0144515 A1
(43) Pub. Date: May 25, 2017

(54) VEHICLE DOOR SASH

(71) Applicant: SHIROKI CORPORATION, Fujisawa-shi (JP)

(72) Inventor: Jun MAKITA, Fujisawa-shi (JP)

(73) Assignee: SHIROKI CORPORATION, Fujisawa-shi (JP)

(21) Appl. No.: 14/950,888

(22) Filed: Nov. 24, 2015

(51) Int. Cl. B60J 5/04

(52) U.S. Cl. CPC B60J 5/0402; B60J 5/0463

(57) ABSTRACT

A vehicle door sash includes an outer member having a glass run channel which is open to an inner peripheral side; an inner member positioned closer to a vehicle interior side than the glass run channel and includes an inner frame portion, end portions of the inner frame portion and the glass run channel are joined at the inner peripheral side; a glass-run holding portion provided on the end portion of the glass run channel to hold a side portion, of the glass run, which is positioned on the vehicle interior side; and a joining portion, provided on the end portion of the glass run channel, welded to the end portion of the inner frame portion, with an end of the joining portion positioned inside the inner frame portion relative to an end of the end portion of the inner frame portion and the glass-run holding portion.

### BACKGROUND OF THE INVENTION

1. Field of the Invention

The present invention relates to a vehicle door sash.

2. Description of Related Art

A structure for door sashes constituting components of a vehicle door (for example, side sashes (upright pillar sashes) that extend along a center pillar) in which an outer member that is a molded article and is provided with a glass run channel for holding a glass run, and an inner member that is a molded article and includes an inner frame portion that projects toward the vehicle interior with respect to the glass run channel are joined together to form a sash, is known in the art. The glass run channel of the outer member has the shape of a channel section which is open toward the sash inner periphery, on which a window opening is formed, and the inner frame portion of the inner member has a sack-like sectional shape which is open to the vehicle exterior. After the inner member and the outer member are combined so that the opening of the inner frame portion, which is open to the vehicle exterior, is closed by the glass run channel, the vehicle interior side end (outer end portion) of a wall of the glass run channel and the sash inner peripheral side end (inner end portion) of a wall of the inner frame portion are joined to each other. As a method of joining these walls, hemming in which one of the outer end portion and the inner end portion is folded back to hold the other is known in the art. This hemming is disclosed in Japanese Unexamined Patent Publication No. 2008-302788.

In the structure, such as disclosed in the aforementioned publication, in which the outer end portion of the outer member and the inner end portion of the inner member are joined by hemming, there has been a problem with the joining portion having low in degree of design flexibility. To increase the degree of design flexibility, it is possible to join the outer end portion and the inner end portion by welding instead of hemming; however, if the outer end portion and the inner end portion are joined by welding, there is a possibility of welding marks protruding inside the glass run channel to interfere with the glass run, thereby deteriorating the appearance of the door sash. FIGS. 11 and 12 each show a joining structure, of the related art, which easily causes such problems and in which the outer member and the inner member are joined to each other by welding.

In a configuration which is common to the structures shown in FIGS. 11 and 12, an outer end portion 52, the end of which points toward the sash inner periphery (toward the associated window opening), is formed on a vehicle interior side wall which constitutes part of a glass run channel 51 of an outer member 50, and an inner end portion 57, the end of which points toward the vehicle exterior is formed on a sash inner peripheral side wall which constitutes part of an inner frame portion 56 of an inner member 55. A glass run 60 made of an elastic material is held in the glass run channel 51. The glass run 60 is provided with a vehicle-interior-side side portion 61 which extends along the outer end portion 52 of the outer member 50 and a support lip 62 which projects toward the vehicle interior from the end of the vehicle-interior-side side portion 61 and comes in contact with the inner end portion 57 of the inner member 55. The inner frame portion 56, especially a predetermined portion thereof except the inner end portion 57 that is covered by the support lip 62 is in a region visible from the vehicle interior side.

In the joining structure shown in FIG. 11, the end of the outer end portion 52 of the outer member 50 is folded back toward the vehicle interior, so that this folded portion of the outer end portion 52 faces a side of the inner end portion 57 of the inner member 55 in the vicinity of the end (the lower end with respect to FIG. 11) of the inner end portion 57. A surface (a lower surface with respect to FIG. 11) of the outer end portion 52 which faces toward the vehicle exterior and the end of the inner end portion 57 (the end surface of the inner end portion 57 that faces toward the vehicle exterior) are joined together by welding. A weld bead W11 that is formed as a result of this welding has a shape protruding toward the vehicle exterior (i.e., toward the inside of the glass run channel 51) from the outer end portion 52 and the inner end portion 57. The weld bead W11 interferes with the vehicle-interior-side side portion 61 of the glass run 60 if the weld bead W11 is not machined down (either using a cutting tool or a grinding tool) after welding.

In the joining structure shown in FIG. 12, the end (the end surface that faces toward the vehicle exterior) of the inner end portion 57 of the inner member 55 faces a side of the outer end portion 52 of the outer member 50 at the end (the left end with respect to FIG. 12) of the outer end portion 52. A surface of the inner end portion 57 which faces toward the sash inner periphery and the edge of the outer end portion 52 (the end surface of the outer end portion 52 that faces toward the sash inner periphery) are joined together by welding. A weld bead W12 that is formed as a result of this welding has a shape that protrudes toward the sash inner periphery from the outer end portion 52 and the inner end portion 57. The weld bead W12 interferes with the support lip 62 of the glass run 60 if the weld bead W12 is not machined down after welding. In addition, there is a possibility of the weld bead W12 entering the visible range of the inner frame portion 56, thus deteriorating the appearance.

In the joining structures shown in FIGS. 11 and 12, to prevent the above described problems from occurring, it is required to perform a finishing operation in which the weld bead W11 and the weld bead W12 are substantially machined down, which makes the post-welding process troublesome. In addition, in the case where the ends of the outer end portion 52 and the inner end portion 57 are butted against each other to be welded, as shown in FIGS. 11 and 12, attention must also be paid to poor joining due to thermal strain of the outer end portion 52 and the inner end portion 57 occurring during welding.

### SUMMARY OF THE INVENTION

The present invention has been devised in view of the above problems and provides a vehicle door sash which is less apt to interfere with a glass run and adversely influence the appearance of the door at welding parts between the glass run channel of the outer member and the inner frame portion of the inner member, and which makes it possible to save time and effort in the finishing operation after welding.

According to an aspect of the present invention, a vehicle door sash is provided, including an outer member which includes a glass run channel having a groove-shaped sectional shape which is open to an inner peripheral side of the vehicle door sash on which a window opening is formed; an inner member which is positioned closer to a vehicle interior side than the glass run channel and includes an inner frame portion, having a sack-like sectional shape which is open to a vehicle exterior, wherein an end portion of the inner frame portion and an end portion of the glass run channel of the outer member are joined to each other at the inner peripheral side; a glass-run holding portion which is provided on the end portion of the glass run channel to hold a side portion, of the glass run, which is positioned on the vehicle interior side; and at least one joining portion, provided on the end portion of the glass run channel, which is joined to the end portion of the inner frame portion by welding, with an end of the joining portion positioned inside the inner frame portion with respect to both an end, on the vehicle exterior side, of the end portion of the inner frame portion and the glass-run holding portion.

It is desirable for the glass run channel to include a vehicle exterior side wall portion, a vehicle interior side wall portion, and a bottom wall. The vehicle exterior side wall portion and the vehicle interior side wall portion extend toward the inner peripheral side from the bottom wall and are spaced from each other in opposite directions toward the vehicle exterior side and the vehicle interior side. The joining portion includes a bent end portion which is bent toward the inside of the inner frame portion with respect to the vehicle interior side wall portion.

It is desirable for the glass run channel to include a vehicle exterior side wall portion, a vehicle interior side wall portion, and a bottom wall. The vehicle exterior side wall portion and the vehicle interior side wall portion extend toward the inner peripheral side from the bottom wall and are spaced from each other in opposite directions toward the vehicle exterior side and the vehicle interior side. The joining portion includes a stepped end portion which is stepped toward the inside of the inner frame portion with respect to the vehicle interior side wall portion.

It is desirable for the end portion of the inner frame portion to have a shape which bends in a direction one of toward and away from the end portion of the glass run channel. Such a bending shape (bent shape) is advantageous for suppressing the influence caused by thermal strain in welding.

It is desirable for the joining portion to include a folded portion, formed on the end portion of the glass run channel, which is folded back toward the inside of the inner frame portion and overlaps part of the joining portion.

It is desirable for the end of the joining portion to be in noncontact with the end portion of the inner frame portion.

In an embodiment, a vehicle door sash is provided, including an outer member which includes a glass run channel having a groove-shaped sectional shape which is open to an inner peripheral side of the vehicle door sash on which a window opening is formed; an inner member which is positioned closer to a vehicle interior side than the glass run channel and includes an inner frame portion, having a sack-like sectional shape which is open to a vehicle exterior, wherein an end portion of the inner frame portion and an end portion of the glass run channel of the outer member are joined to each other at the inner peripheral side; a lip contacting portion, which is provided on the end portion of the inner frame portion, with which a support lip portion of the glass run which is positioned on the vehicle interior side comes in contact; and at least one joining portion, provided on the end portion of the inner frame portion, which is joined to the end portion of the glass run channel by welding, with an end of the joining portion positioned inside the inner frame portion with respect to both an end, on the inner peripheral side, of the end portion of the glass run channel and the lip contacting portion.

It is desirable for the joining portion to include a folded portion, formed on the end portion of the inner frame portion, which is folded back toward the inside of the inner frame portion and overlaps part of the joining portion.

It is desirable for the end of the joining portion to be in noncontact with the end portion of the of the glass run channel.

It is desirable for the joining portion to include a plurality of joining portions which are formed at different positions in a lengthwise direction of the vehicle door sash.

According to the present invention, by forming the joining portion, which is positioned inside the inner frame portion with respect to the glass-run holding portion and the lip contacting portion, at the end of the glass run channel or the end portion of the inner frame portion, which is to be welded, a welding mark (e.g., weld bead) can be prevented from protruding inside the glass run channel, from protruding toward the sash inner peripheral side, or from being exposed to the sash inner peripheral side, thus making it possible to achieve a vehicle door sash in which a welding mark is less likely to interfere with a glass run and is less likely to adversely influence the appearance of the door. Additionally, since the vehicle door sash according to the present invention has a structure in which an end portion of the glass run channel and an end of the inner frame portion are welded, these ends do not have to be joined by hemming, and accordingly, the vehicle door sash according to the present invention is superior in degree of design flexibility compared with a hemming joint structure.

### BRIEF DESCRIPTION OF THE DRAWINGS

The present invention will be discussed below in detail with reference to the accompanying drawings, in which:

FIG. 1 is a side elevational view of a motor-vehicle door (side door) having a door sash to which the present invention has been applied;

FIG. 2 is a cross sectional view of a first embodiment of a side sash (rear side sash), taken along the line II-II shown in FIG. 1 and viewed in the direction of the appended arrows;

FIG. 3 is an enlarged sectional view of a joining portion between the glass run channel of the outer member and the inner frame portion of the inner member in the first embodiment of the side sash;

FIG. 4 is a perspective view of a portion of the outer member, which constitutes an element of the first embodiment of the side sash;

FIG. 5 is a sectional view of a second embodiment of the joining portion between the glass run channel of the outer member and the inner frame portion of the inner member;

FIG. 6 is a sectional view of a third embodiment of the joining portion between the glass run channel of the outer member and the inner frame portion of the inner member;

FIG. 7 is a sectional view of a fourth embodiment of the joining portion between the glass run channel of the outer member and the inner frame portion of the inner member;

FIG. 8 is a sectional view of a fifth embodiment of the joining portion between the glass run channel of the outer member and the inner frame portion of the inner member;

FIG. 9 is a sectional view of a sixth embodiment of the joining portion between the glass run channel of the outer member and the inner frame portion of the inner member;

FIG. 10 is a sectional view of a seventh embodiment of the joining portion between the glass run channel of the outer member and the inner frame portion of the inner member;

FIG. 11 is an enlarged sectional view of an example of a joining structure between the glass run channel of the outer member and the inner frame portion of the inner member in a door sash of the related art; and

FIG. 12 is an enlarged sectional view of a different example of a joining structure between the glass run channel of the outer member and the inner frame portion of the inner member in a door sash of the related art.

### DESCRIPTION OF THE EMBODIMENTS

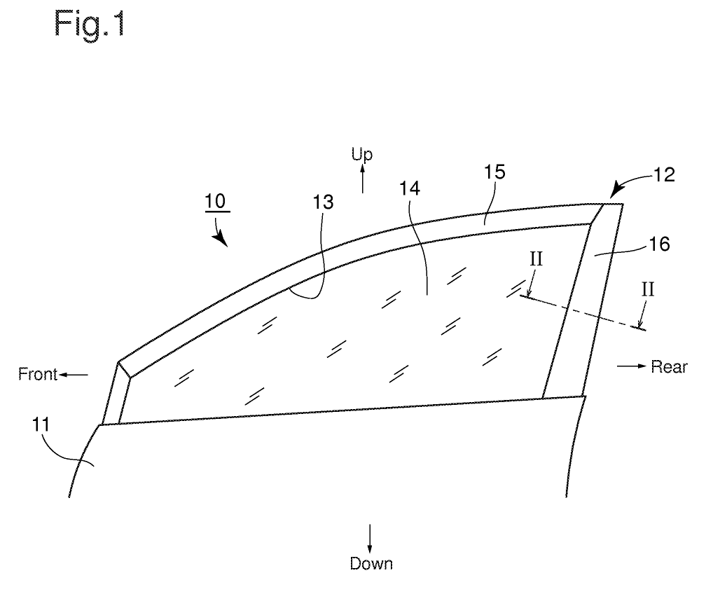

A motor-vehicle side door 10 shown in FIG. 1 is provided with a door panel 11 and a door sash 12 which is formed in a frame shape on top of the door panel 11. A window pane 14 moves up and down in a window opening 13 which is surrounded by the upper edge of the door panel 11 and the inner periphery of the door sash 12. The door sash 12 is provided with an upper sash 15 and a side sash (upright pillar sash) 16. The upper sash 15 forms the upper edge of the door 10, and the side sash 16 extends upward in the vertical direction from the rear of the door panel 11. The door 10 is for use as a front-seat door. Terms indicating a direction such as the “front”, “rear”, “up”, “down”, “vehicle interior side” and “vehicle exterior side” will be mentioned in the following descriptions to designate directions determined with reference to the vehicle body, to which the door 10 which is for use as a front-seat door is attached. Additionally, the side sash 16 will be discussed hereinafter; in the following descriptions, the side of the door sash 16 adjacent to (facing) the window opening 13 will be referred to as the inner peripheral side, and the opposite side of the door sash 16 from the inner peripheral side (which faces the associated door opening of the vehicle body (faces the associated center pillar of the vehicle body)) will be referred to as the outer peripheral side. In a state where the door 10 is closed, the inner peripheral side of the side sash 16 approximately faces toward the front of the vehicle and the outer peripheral side of the side sash 16 approximately faces toward the rear of the vehicle.

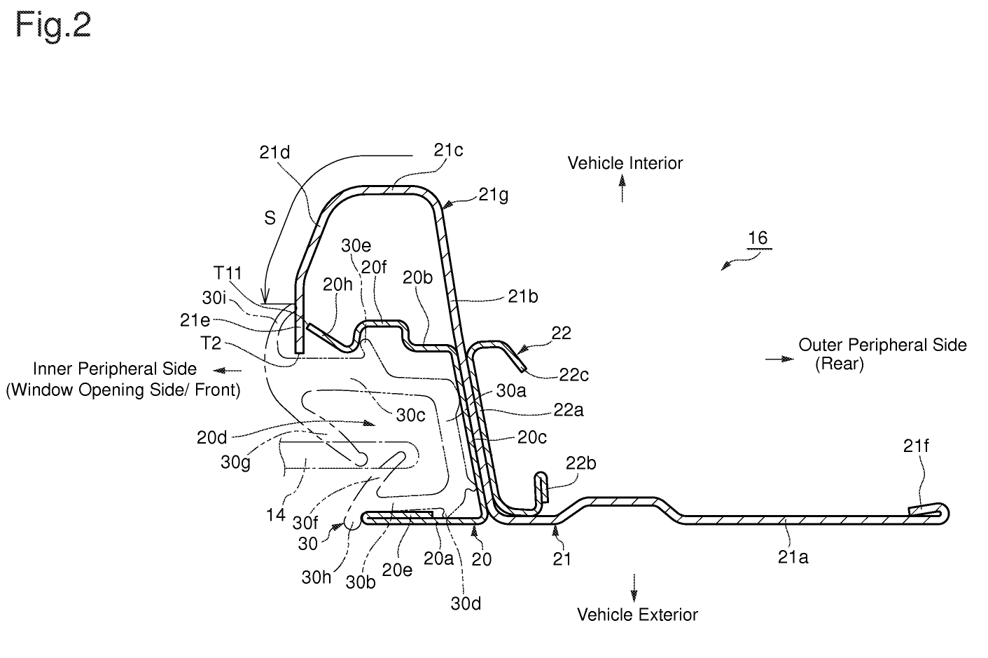

FIG. 2 shows the cross sectional structure of the first embodiment of the side sash 16 according to the present invention. The side sash 16 is formed by combining an outer member 20, an inner member 21 and an auxiliary member 22. The outer member 20 is provided with a design portion (vehicle exterior side wall portion) 20a, a vehicle interior side wall portion 20b and a base wall 20c. The design portion 20a faces toward the vehicle exterior, the vehicle interior side wall portion 20b faces the design portion 20a and is positioned on the vehicle interior side, and the base wall 20c connects the outer peripheral side ends of the design portion 20a and the vehicle interior side wall portion 20b. The region of the side sash 16 which is surrounded by the design portion 20a, the vehicle interior side wall portion 20b and the base wall 20c is formed as a glass run channel 20d having a bottomed-groove sectional shape which is open to the inner peripheral side. The inner-peripheral-side end of the design portion 20a is folded back toward the vehicle interior to form a folded portion 20e. The outer member 20 is further provided at a center of the vehicle interior side wall portion 20b with a vehicle interior side projecting portion 20f which projects toward the vehicle interior.

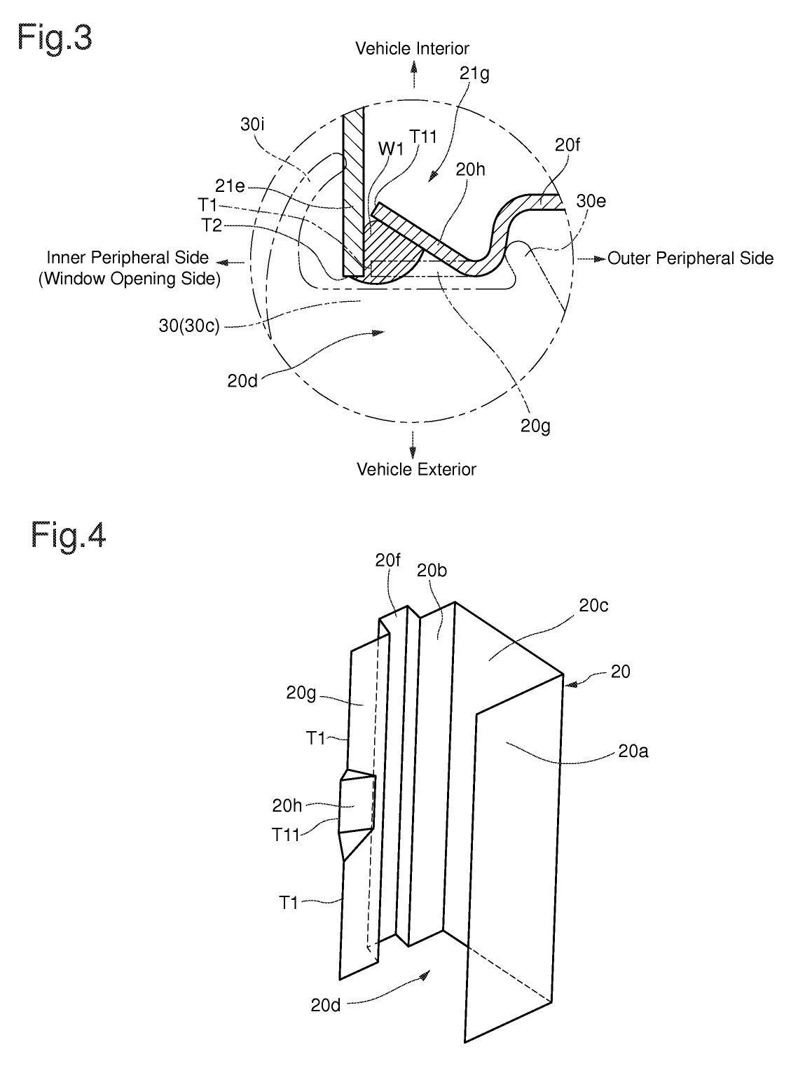

As shown in FIGS. 3 and 4, the vehicle interior side wall portion 20b is provided with an inner peripheral side flange (part of the vehicle interior side wall portion/an outer end portion/a glass-run holding portion) 20g which is continuous with the vehicle interior side projecting portion 20f and projects toward the inner peripheral side. T1 shown in the drawings designates the end of the inner peripheral side flange 20g. A plurality of bent end portions (joining portions) 20h are formed on the inner peripheral side flange 20g at different positions in the lengthwise direction of the side sash 16 (part of the side sash 16 which includes only one bent end portion 20h is shown in FIG. 4). Each bent end portion 20h has a bent shape, being inclined toward the vehicle interior away from the inner peripheral side flange 20g, in a direction from the outer peripheral side toward the inner peripheral side, with the end of the bent end portion 20h that is connected to the vehicle interior side projecting portion 20f as a point of origin. T11 shown in the drawings designates the end of one of the plurality of bent end portions 20h.

As shown in FIG. 2, the inner member 21 is provided with a design portion 21a, an inwardly extending portion (outer peripheral side wall portion) 21b, a connecting portion 21c and an outwardly extending portion (inner peripheral side wall portion) 21d. The design portion 21a faces toward the vehicle exterior, similar to the design portion 20a of the outer member 20. The inwardly extending portion 21b is formed to extend toward the vehicle interior along the base wall 20c of the outer member 20 by bending the inner peripheral side end of the design portion 21a toward the vehicle interior. The connecting portion 21c is continuous with the inwardly extending portion 21b and extends in the forward and rearward directions of the vehicle. The outwardly extending portion 21d is formed to extend toward the vehicle exterior by bending a portion of the connecting portion 21c on the inner peripheral side toward the vehicle exterior side. The inwardly extending portion 21b has an inclined shape, approaching the inner peripheral side (forwardly) in a direction toward the vehicle interior side from the vehicle exterior side. The outwardly extending portion 21d has a generally inclined shape, approaching toward the inner peripheral side (approaching forwardly) in a direction toward the vehicle exterior side from the vehicle interior side, and a portion of the outwardly extending portion 21d in the vicinity of the end thereof which faces toward the vehicle exterior is formed as a vehicle exterior side flange (part of the inner peripheral side wall portion/an inner end portion/a lip contacting portion) 21e, which has almost no inclination with respect to the forward and rearward directions, thus substantially extending in the vehicle exterior direction. T2 shown in the drawings designates the end of the vehicle exterior side flange 21e. The inner member 21 is provided at the outer peripheral side end of the design portion 21a with a folded portion 21f, which is formed by folding back the outer peripheral side end of the design portion 21a toward the vehicle interior. The inwardly extending portion 21b, the connecting portion 21c, the outwardly extending portion 21d and the vehicle exterior side flange 21e of the inner member 21 constitute an inner frame portion 21g which projects toward the vehicle interior with respect to the glass run channel 20d of the outer member 20. The inner frame portion 21g progressively increases in width in a direction toward the vehicle exterior side from the vehicle interior side due to the inclination of the inwardly extending portion 21b and the outwardly extending portion 21d, and has a sack-like sectional shape which is open to the vehicle exterior.

As shown in FIG. 2, the auxiliary member 22 is provided with a base portion 22a and a pair of retaining portions 22b and 22c. The base portion 22a is laid on the inwardly extending portion 21b, and the pair of retaining portions 22b and 22c are formed by bending the vehicle interior side end and the vehicle exterior side end of the base portion 22a toward each other. The region of the side sash 16 which is surrounded by the base portion 22a, the pair of retaining portions 22b and 22c of the auxiliary member 22 and the design portion 21a of the inner member 21 defines a weather-strip retaining recess in which a weather strip (not shown) is fitted and retained. This weather strip includes a leg portion which is fitted into the pair of retaining portions 22b and 22c of the auxiliary member 22 and an elastic contacting portion which projects toward the sash outer peripheral side. When the door 10 is closed, the elastic contacting portion of the weather strip comes into contact with the vehicle body and is elastically deformed to thereby prevent water and moisture, etc., from entering the vehicle interior.

The outer member 20, the inner member 21 and the auxiliary member 22 are formed as separate members, and are thereafter joined together to form the side sash 16. The base wall 20c of the outer member 20, the inwardly extending portion 21b of the inner member 21 and the base portion 22a of the auxiliary member 22 are layered and joined together by pressure welding (e.g., spot welding). In addition, the end (also referred to as the outer end portion) of the inner peripheral side flange 20g of the glass run channel 20d of the outer member 20 and the end (also referred to as the inner end portion) of the vehicle exterior side flange 21e of the inner frame portion 21g of the inner member 21 are adjacent to each other and fixed to each other. More specifically, the plurality of bent end portions 20h, which are formed on the outer end portion of the outer member 20, and the inner end portion (the vehicle exterior side flange 21e) of the inner member 21 are joined together by fusion welding (e.g., arc welding). The inner member 21 alone is shaped so that the inner frame portion 21g is open to the vehicle exterior, and joining the outer member 20 and the inner member 21 to each other as shown in FIG. 2 causes the vehicle interior side wall portion 20b (which includes the vehicle interior side projecting portion 20f, the inner peripheral side flange 20g and the plurality of bent end portions 20h) of the outer member 20 to close the opening of the inner frame portion 21g that faces toward the vehicle exterior, so that a combination of the outer member 20 and the inner member 21 thus joined together forms a closed cross-sectional shape.

As shown in FIG. 2, a glass run 30 made of an elastic material is fitted into the glass run channel 20d in a state where the outer member 20, the inner member 21 and the auxiliary member 22 are joined together. The glass run 30 is provided with a base portion 30a, a pair of side portions 30b and 30c, retaining projections 30d and 30e, elastic lips 30f and 30g, and support lips 30h and 30i. The base portion 30a abuts against the base wall 20c of the outer member 20. The pair of side portions 30b and 30c are supported along the design portion 20a (which includes the folded portion 20e) and the vehicle interior side wall portion 20b (which includes the vehicle interior side projecting portion 20f and the inner peripheral side flange 20g), respectively. The elastic lips 30f and 30g extend from the ends of the pair of side portions 30b and 30c in directions to approach each other, respectively. The support lip 30h projects in the direction opposite from the projecting direction of the elastic lip 30f and the support lip 30i projects in the direction opposite from the projecting direction of the elastic lip 30g. Both sides of the glass run 30 are retained by the folded portion 20e and the inner peripheral side flange 20g, which face the side portion (vehicle-exterior-side side portion) 30b and the side portion (vehicle-interior-side side portion) 30c, respectively. The glass run 30 is prevented from coming off toward the inner peripheral side from the sash member 16 by engagement of the retaining projections 30d and 30e with the folded portion 20e and the vehicle interior side projecting portion 20f. The elastic lips 30f and 30g come in contact with and are elastically deformed by the window pane 14 that is slid into the glass run channel 20d, thus reducing vibrations and noise accompanied thereby. FIG. 2 shows the shapes of the elastic lips 30f and 30g in a free state, i.e., in a state before being elastically deformed. The support lip 30h, which is positioned closer to the vehicle exterior side than the support lip 30i, is engaged with the folded end between the design portion 20a and the folded portion 20e to support the elastic lip 30f so that the elastic lip 30f contacts the vehicle exterior side of the window pane 14 with an appropriate pressure. In addition, the support lip 30i, which is positioned closer to the vehicle interior side than the support lip 30h, is engaged with a side of the vehicle exterior side flange 21e of the inner member 21 to support the elastic lip 30g so that the elastic lip 30g contacts the vehicle interior side of the window pane 14 with an appropriate pressure.

A portion of the inner frame portion 21g, of the inner member 21 (of the side sash 16), that ranges from the connecting portion 21c to the vehicle exterior side flange 21e is visible from the vehicle interior side in a state where the door 10 is closed, and this visible range is designated by a letter S in FIG. 2. Part of the vehicle exterior side flange 21e is covered with the support lip 30i of the glass run 30, and thus cannot be seen externally.

FIG. 3 shows an enlarged sectional view of the joining portion between one of the plurality of bent end portions 20h of the outer member 20 and the vehicle exterior side flange 21e of the inner member 21. In FIG. 3, for the outer member 20, the shape of a portion of the inner peripheral side flange 20g at which none of the plurality of bent end portions 20h are formed is shown by a two-dot chain line, while the shape of each bent end portion 20h is shown by a solid line. As can be seen from FIG. 3, the end T11 of the bent end portion 20h is positioned on the vehicle interior side (i.e., inside the inner frame portion 21g) with respect to the inner peripheral flange 20g that holds the side portion 30c, which is positioned on the vehicle interior side, with the end T2 of the vehicle exterior side flange 21e (the inner end portion) as a reference, and a triangular space which is recessed toward the vehicle interior with respect to the glass run channel 20d is formed between the bent end portion 20h and the vehicle exterior side flange 21e that is positioned adjacent to the inner peripheral side of the bent end portion 20h. Additionally, upon each bent end portion 20h and the vehicle exterior side flange 21e being joined to each other by welding from the inside of the glass run channel 20d, a weld bead (welding mark) W1 is formed within the aforementioned triangular space. Each of the plurality of bent end portions 20h, which are provided at different positions in the lengthwise direction of the side sash 16, is joined to the vehicle exterior side flange 21e in the manner shown in FIG. 3.

In the structure shown in FIG. 3, although the weld bead W1 faces the inside of the glass channel 20d, since each bent end portion 20h, which has a shape that is recessed toward the inside of the inner frame portion 21g with respect to the inner peripheral side flange 20g (toward the vehicle interior with the inner peripheral side flange 20g as a reference), is defined as a welding part, the weld bead W1 is accommodated in the space secured due to the recessed shape of each bent end portion 20h, which minimizes the amount of protrusion of the weld bead W1 into the inside of the glass run channel 20d. Even though the weld bead W1 shown in FIG. 3 is in a non-machined state, the weld bead W1 hardly protrudes toward the vehicle exterior (into the inside of the glass run channel 20d) with respect to the inner peripheral side flange 20g. In addition, the vehicle exterior side flange 21e is positioned on the inner peripheral side of the weld bead W1; hence, the weld bead W1 cannot protrude beyond the vehicle exterior side flange 21e toward the inner peripheral side of the side sash 16. This makes it possible to prevent the weld bead W1 from interfering with the side portion 30c or the support lip 30i of the glass run 30 with no need to machine down (either using a cutting tool or a grinding tool) the weld bead W1, or only a small amount of machining even if the weld bead W1 needs to be machined down. Furthermore, because the weld bead W1 is covered by the vehicle exterior side flange 21e without being exposed to the inner peripheral side of the side sash 16, the appearance of the inner frame portion 21g in the visible range thereof is not deteriorated after welding. Accordingly, the side sash 16 that is superior in ability to retain the glass run 30 and appearance of the inner frame portion 21g can be achieved without spending time and labor on the post-welding process after welding (such as machining down the weld bead W1). Moreover, there is the advantage that a wide field of vision can be secured at the inner periphery of the window opening 13 because the side sash 16 is structured so that the joined portion between each bent end portion 20h and the vehicle exterior side flange 21e does not project toward the inner peripheral side of the side sash 16. Although a gap exists between the end T11 of each bent end portion 20h and the vehicle exterior side flange 21e in the structure shown in FIG. 3, the length of each bent end portion 20h can be adjusted to eliminate such a gap.

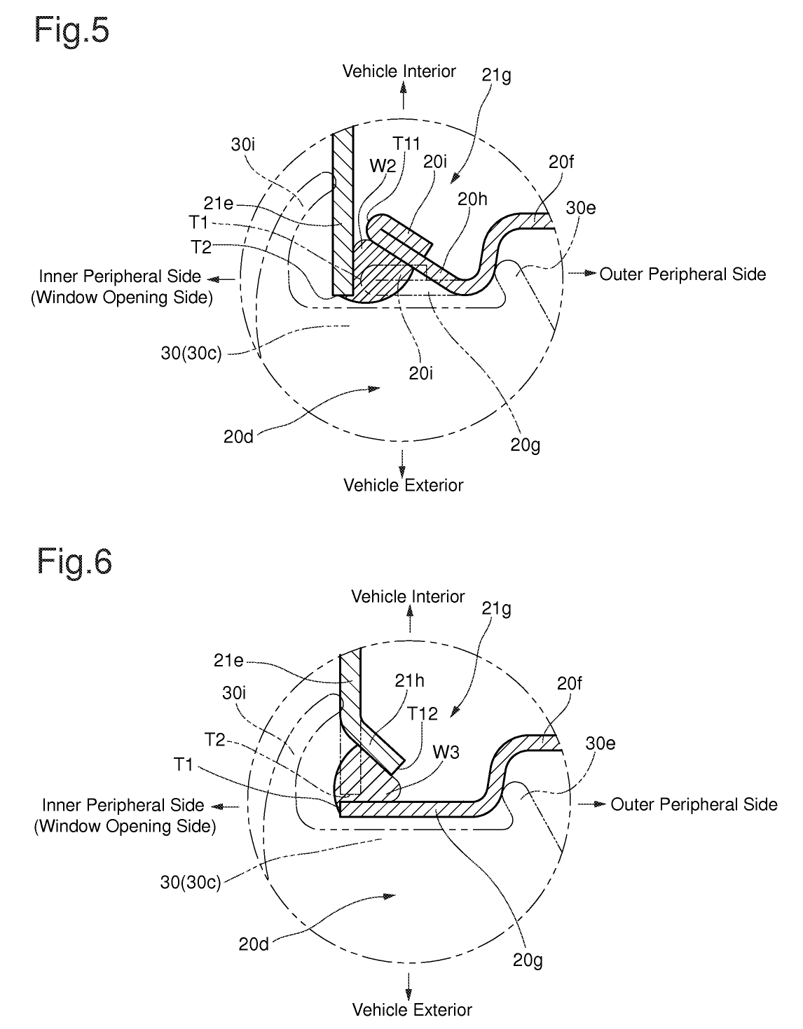

In the second embodiment shown in FIG. 5, in addition to the structure in the above described first embodiment, a folded portion 20i which is folded back toward the vehicle interior (i.e., toward the inside of the inner frame portion 21g) is formed at each of the end T1 of the inner peripheral flange 20g of the outer member 20 and the end T11 of each bent end portion 20h of the outer member 20; hence, the folded portion 20i overlaps each bent end portion 20h. The formation of the folded portion 20i that folds back onto the underside of each bent end portion 20h increases the thickness of the welding part and improves heat resistance during welding, thus achieving the effect of suppressing thermal strain. Since the relationship between each bent end portion 20h and the vehicle exterior side flange 21e that are to be welded in the second embodiment is identical to that in the first embodiment, a weld bead (weldung mark) W2 of the second embodiment that is shown in FIG. 5 is substantially identical in shape to the weld bead W1 of the first embodiment. Although a gap exists between the end T11 of each bent end portion 20h (the boundary between each bent end portion 20h and the associated folded portion 20i) and the vehicle exterior side flange 21e in the structure shown in FIG. 5, the length of each bent end portion 20h can be adjusted to eliminate such a gap.

In the third embodiment shown in FIG. 6, instead of forming the plurality of bent end portions 20h on the outer member 20 as described in the first and second embodiments, a plurality of bent end portions (joining portions) 21h which are shaped to increase the amount of projection thereof toward the outer peripheral side away from a plane in which the vehicle exterior side flange 21e lies in a direction toward the vehicle exterior side are formed at the inner end portion of the vehicle exterior side flange 21e. T12 shown in FIG. 6 designates the end of one of the plurality of bent end portions 21h. Similar to the plurality of bent end portions 20h of the previous embodiments, the plurality of bent end portions 21h are formed at different positions in the lengthwise direction of the side sash 16 in the third embodiment. The end T12 of each bent end portion 21h is positioned on the outer peripheral side (i.e., inside the inner frame portion 21g) with respect to the vehicle exterior side flange 21e, with which the support lip 30i (which is positioned closer to the vehicle interior side than the support lip 30h) is in contact, with the end T1 of the inner peripheral side flange 20g (the outer end portion) as a reference, and a triangular space which is recessed toward the outer peripheral side with respect to the vehicle exterior side flange 21e is formed between each bent end portion 21h and the inner peripheral side flange 20g that is positioned adjacent to the vehicle exterior side of the bent end portion 21h. Additionally, upon each bent end portion 21h and the inner peripheral side flange 20g being joined to each other by welding from the inner peripheral side, a weld bead (welding mark) W3 is formed within the aforementioned triangular space.

In the structure shown in FIG. 6, although the weld bead W3 faces the inner peripheral side of the side sash 16, because each bent end portion 21h, which has a shape that is recessed toward the inside of the inner frame portion 21g with respect to the vehicle exterior side flange 21e (toward the outer peripheral side with the vehicle exterior side flange 21e as a reference), is defined as a welding part, the weld bead W3 is accommodated in the space secured by the formation of each bent end portion 21h, which minimizes the amount of protrusion of the weld bead W3 toward the inner peripheral side of the side sash 16. Even though the weld bead W3 shown in FIG. 6 is in a non-machined state, the weld bead W3 hardly protrudes toward the inner peripheral side with respect to the vehicle exterior side flange 21e. In addition, the inner peripheral side flange 20g is positioned on the vehicle exterior side of the weld bead W3; hence, the weld bead W3 cannot protrude beyond the inner peripheral side flange 20g into the inside of the glass run channel 20d. This makes it possible to prevent the weld bead W3 from interfering with the support lip 30i or the side portion 30c with no need to machine down the weld bead W3, or only a small amount of machining even if the weld bead W3 needs to be machined down. Additionally, by securing the welding width by each bent end portion 21h that is formed obliquely with respect to the vehicle exterior side flange 21e, which is extended in the door thickness direction that connects the vehicle interior and the vehicle exterior, the widths of the weld bead W3 and each bent end portion 21h in the door thickness direction can be minimized. Accordingly, the welded parts that include the weld beads W3 can be securely covered with the support lip 30i of the glass run 30, and hence, the appearance of the inner frame portion 21g in the visible range thereof is not deteriorated after welding. Also with the structure shown in FIG. 6, the side sash 16 that is superior in ability to retain the glass run 30 and appearance of the inner frame portion 21g can be achieved without spending time and labor on the post-welding process after welding. Moreover, a wide field of vision can be secured at the inner periphery of the window opening 13 because the side sash 16 is structured so that the joined portion between each bent end portion 21h and the inner peripheral side flange 20g does not project toward the inner peripheral side of the side sash 16. As a modification of the embodiment shown in FIG. 6, it is possible to provide the inner member 21 with a folded portion like the folded portion 20i (shown in FIG. 5) which is formed on each bent end portion 21h to be continuous therewith. Although a gap exists between the end T12 of each bent end portion 21h and the inner peripheral side flange 20g in the structure shown in FIG. 6, the length of each bent end portion 21h can be adjusted to eliminate such a gap.

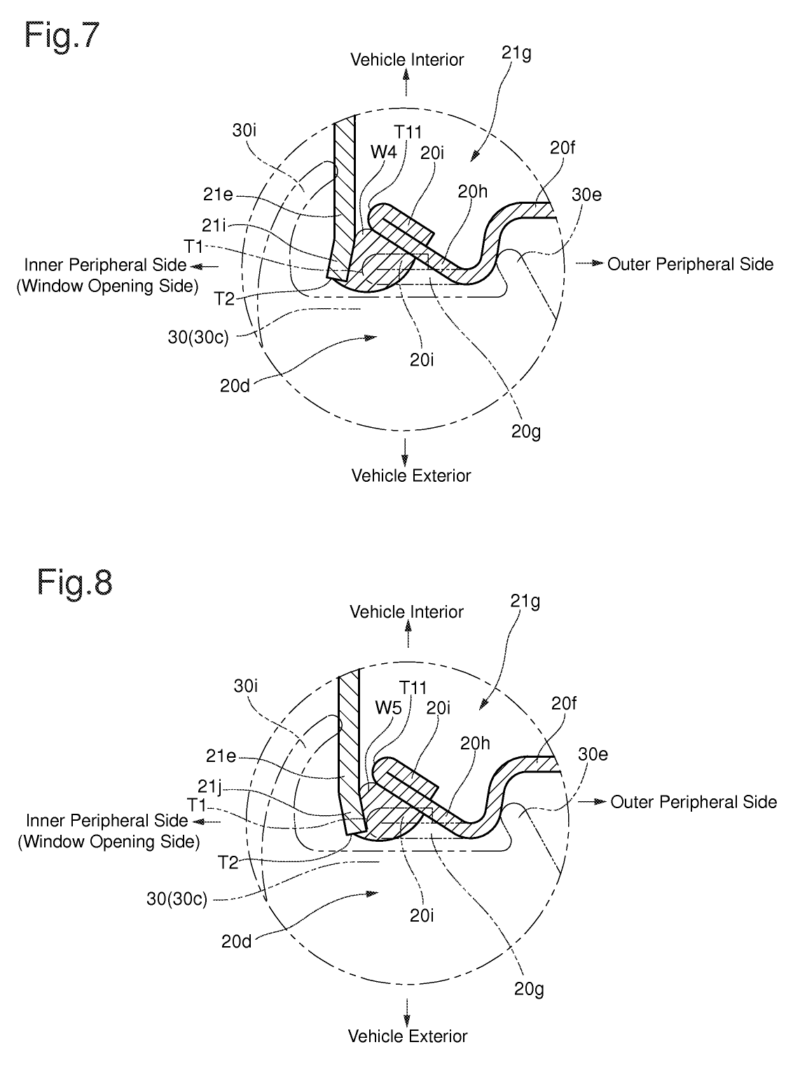

The fourth embodiment shown in FIG. 7 and the fifth embodiment shown in FIG. 8 are identical to the second embodiment shown in FIG. 5 in regard to the structure of the outer member 20 but different from the second embodiment shown in regard to the shape of the inner end portion of the vehicle external flange 21e of the inner member 21.

In the fourth embodiment shown in FIG. 7, bent end portions 21i which are shaped to increase the amount of projection thereof toward the inner peripheral side in a direction toward the vehicle exterior side are formed at the inner end portion of the vehicle exterior side flange 21e. Namely, the bent end portions 21i are shaped to bend in a direction away from the bent end portions 20h of the outer member 20. Each bent end portion 21i and the associated bent end portion 20h are joined by welding, thereby forming a weld bead (welding mark) W4 therebetween.

In the fifth embodiment shown in FIG. 8, a plurality of bent end portions 21j which are shaped to increase the amount of projection thereof toward the outer peripheral side in a direction toward the vehicle exterior side are formed at the inner end portion of the vehicle exterior side flange 21e. Namely, the bent end portions 21j are shaped to bend in a direction to approach the bent end portions 20h of the outer member 20. Each bent end portion 21j and the associated bent end portion 20h are joined by welding, thereby framing a weld bead (welding mark) W5 therebetween.

Thermal strain can be reduced by forming each welding part of the vehicle exterior side flange 21e which faces the associated bent end portion 20h into a bent end shape such as the bent end portion 21i or 21j. The bend angle of each bent end portion 21i, which is shaped to bend toward the inner peripheral side, is limited to a small degree of angle so that each bent end portion 21i does not interfere with the support lip 30i of the glass run 30. Whereas, the bend angle of each bent end portion 21j, which is shaped to bend toward the outer peripheral side, is limited to a small degree of angle so as to be capable of securing a welding space between each bent end portion 21j and the associated bent end portion 20h.

Although the bent end portions 21i or 21j are formed on the inner member 21 in each of the embodiments shown in FIGS. 7 and 8, it is also possible to form bent end portions corresponding the bent end portions 21i or 21j on the outer end portion of the inner peripheral flange 20g in the structure shown in FIG. 6.

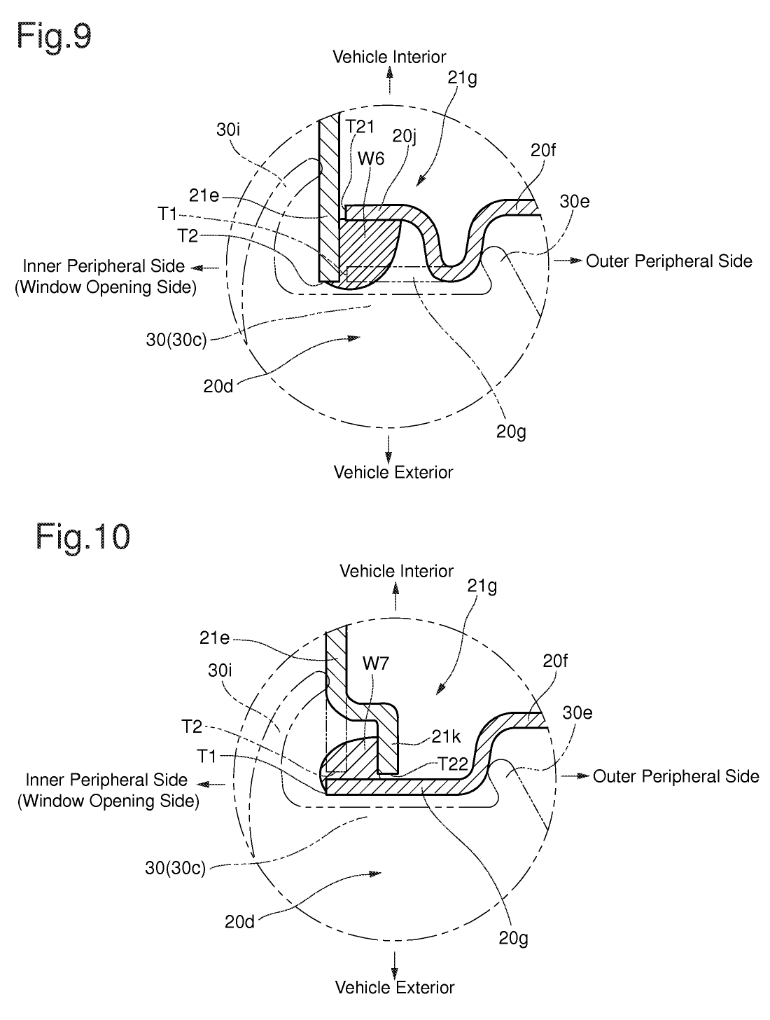

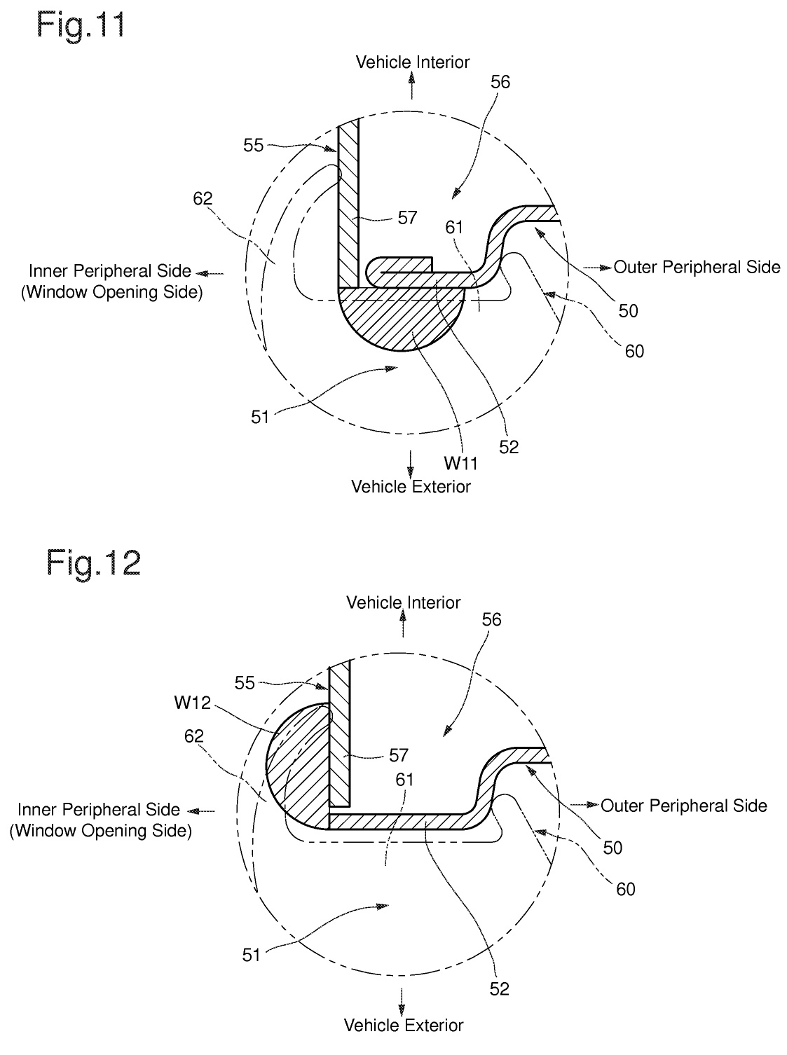

In the sixth embodiment shown in FIG. 9, instead of the bend ends 20h (shown in FIGS. 3 through 5, 7 and 8), a plurality of stepped end portions (joining portions) 20j substantially parallel to the inner peripheral side flange 20g of the outer member 20 are formed on the inner peripheral side flange 20g of the outer member 20 (at different positions in the lengthwise direction of the side sash 16) as joining portions of the outer end portion. The end T21 of each stepped end portion 20j is positioned on the vehicle interior side (i.e., inside the inner frame portion 21g) with respect to the inner peripheral flange 20g, with the end T2 of the vehicle exterior side flange 21e (the inner end portion) as a reference. Upon each stepped end portion 20j and the vehicle exterior side flange 21e being joined to each other by welding from the inside of the glass run channel 20d, a weld bead (welding mark) W6 is formed. A space which is recessed toward the vehicle interior with respect to the inner peripheral flange 20g is formed by the stepped end portion 20j, and the weld bead W6 is accommodated in this space, and accordingly, an effect similar to that obtained in the case where the plurality of bent end portions 20h are formed can be obtained.

In the seventh embodiment shown in FIG. 10, instead of the bend ends 21h (shown in FIG. 6), a plurality of stepped end portions (joining portions) 21k substantially parallel to the vehicle exterior side flange 21e of the inner member 21 are formed on the vehicle exterior side flange 21e of the inner member 21 as joining portions of the inner end portion. The end T22 of each stepped end portion 21k is positioned on the outer peripheral side (i.e., inside the inner frame portion 21g) with respect to the vehicle exterior side flange 21e, with the end T1 of the inner peripheral flange 20g (the outer end portion) as a reference. Upon each stepped end portion 21k and the inner peripheral flange 20g being joined to each other by welding from the inner peripheral side, a weld bead (weldin mark) W7 is formed. A space which is recessed toward the outer peripheral side with respect to the vehicle exterior side flange 21e is formed by the stepped end portion 21k, and the weld bead W7 is accommodated in this space, and accordingly, an effect similar to that obtained in the case where the plurality of bent end portions 21h are formed can be obtained.

As can be seen from FIGS. 9 and 10, the shape of the joining portion provided at the outer end portion of the glass run channel 20d or the inner end portion of the inner frame portion 21g is not limited to a bent shape such as the shapes of the bend ends 20h and 21h and can be any arbitrary shape like the shape of the stepped end portion 20j or 21k. As a modification of the embodiment shown in FIG. 9, it is possible to provide the outer member 20 with a folded portion similar to the folded portion 20i (shown in FIGS. 5, 7 and 8) which is formed on each stepped end portion 20j to be continuous therewith. Likewise, as a modification of the embodiment shown in FIG. 10, it is possible to provide the inner member 21 with a folded portion like the folded portion 20i (shown in FIGS. 5, 7 and 8) which is formed on each stepped end portion 21k to be continuous therewith. Additionally, it is possible to provide a bent end portion like the bent end portion 21i or the bent end portion 21j (shown in FIGS. 7 and 8) at the inner end portion of the vehicle exterior side flange 21e that is joined to the stepped end portion 20j or the outer end portion of the inner peripheral side flange 20g that is joined to the stepped end portion 21k. Although a gap exists between the end T21 of the stepped end portion 20j and the vehicle exterior side flange 21e in the structure shown in FIG. 9, the length of the stepped end portion 20j can be adjusted to eliminate such a gap. Likewise, although a gap exists between the end T22 of the stepped end portion 21k and the inner peripheral side flange 20g in the structure shown in FIG. 10, the length of the stepped end portion 21k can be adjusted to eliminate such a gap.

Although the present invention has been described based on the above illustrated embodiments, the present invention is not limited solely thereto; various modifications to the above illustrated embodiments are possible. For instance, although the side sash 16 in the above illustrated embodiments includes the auxiliary member 22 in addition to the outer member 20 and the inner member 21, the presence or absence of the auxiliary member 22 has nothing to do with the gist of the present invention.

In addition, although each of the above illustrated embodiments is an application example applied to a side sash, the present invention can be applied to not only a side sash but also an upper sash, so long as the sash is structured to have two members that respectively include a glass channel (which corresponds to the glass channel 20d) and an inner frame portion (which corresponds to the inner frame portion 21g) which are joined by welding.

Additionally, although the bent end portions (20h/21h) and the stepped end portions (20j/21k), which constitute joining portions which are to be welded, are intermittently formed at different positions in the lengthwise direction of the side sash in the above illustrated embodiments, it is also possible for joining portions, which correspond to the bent end portions (20h/21h) or the stepped end portions (20j/21k), to be continuously formed in the lengthwise direction (elongated direction) of the sash. The side sash can be produced at low cost by roll forming by forming a continuous joining portion.

In the case where a joining portion is continuously formed in the lengthwise direction of a sash (e.g., a side sash or an upper sash), it is desirable that this joining portion be intermittently welded in the lengthwise direction of the sash. This welding manner makes it possible to reduce influence caused by thermal strain. However, the present invention does not exclude the structure in which the entire part of the joining portion is uniformly (continuously) welded.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A vehicle door sash comprising:
an outer member which includes a glass run channel having a groove-shaped sectional shape which is open to an inner peripheral side of said vehicle door sash on which a window opening is formed;
an inner member which is positioned closer to a vehicle interior side than said glass run channel and includes an inner frame portion, having a sack-like sectional shape which is open to a vehicle exterior, wherein an end portion of said inner frame portion and an end portion of said glass run channel of said outer member are joined to each other at said inner peripheral side;
a glass-run holding portion which is provided on said end portion of said glass run channel to hold a side portion, of said glass run, which is positioned on said vehicle interior side; and
at least one joining portion, provided on said end portion of said glass run channel, which is joined to said end portion of said inner frame portion by welding, with an end of said joining portion positioned inside said inner frame portion with respect to both an end, on said vehicle exterior side, of said end portion of said inner frame portion and said glass-run holding portion.

2. The vehicle door sash according to claim 1, wherein said glass run channel comprises a vehicle exterior side wall portion, a vehicle interior side wall portion and a bottom wall,
wherein said vehicle exterior side wall portion and said vehicle interior side wall portion extend toward said inner peripheral side from said bottom wall and are spaced from each other in opposite directions toward said vehicle exterior side and said vehicle interior side, and
wherein said joining portion comprises a bent end portion which is bent toward said inside of said inner frame portion with respect to said vehicle interior side wall portion.

3. The vehicle door sash according to claim 1, wherein said glass run channel comprises a vehicle exterior side wall portion, a vehicle interior side wall portion and a bottom wall,
wherein said vehicle exterior side wall portion and said vehicle interior side wall portion extend toward said inner peripheral side from said bottom wall and are spaced from each other in opposite directions toward said vehicle exterior side and said vehicle interior side, and
wherein said joining portion comprises a stepped end portion which is stepped toward said inside of said inner frame portion with respect to said vehicle interior side wall portion.

4. The vehicle door sash according to claim 1, wherein said end portion of said inner frame portion has a shape which bends in a direction one of toward and away from said end portion of said glass run channel.

5. The vehicle door sash according to claim 1, wherein said joining portion comprises a folded portion, formed on said end portion of said glass run channel, which is folded back toward said inside of said inner frame portion and overlaps part of said joining portion.

6. The vehicle door sash according to claim 1, wherein said end of said joining portion is in noncontact with said end portion of said inner frame portion.

7. A vehicle door sash comprising:
an outer member which includes a glass run channel having a groove-shaped sectional shape which is open to an inner peripheral side of said vehicle door sash on which a window opening is formed;
an inner member which is positioned closer to a vehicle interior side than said glass run channel and includes an inner frame portion, having a sack-like sectional shape which is open to a vehicle exterior, wherein an end portion of said inner frame portion and an end portion of said glass run channel of said outer member are joined to each other at said inner peripheral side;
a lip contacting portion, which is provided on said end portion of said inner frame portion, with which a support lip portion of said glass run which is positioned on said vehicle interior side comes in contact; and
at least one joining portion, provided on said end portion of said inner frame portion, which is joined to said end portion of said glass run channel by welding, with an end of said joining portion positioned inside said inner frame portion with respect to both an end, on said inner peripheral side, of said end portion of said glass run channel and said lip contacting portion.

8. The vehicle door sash according to claim 7, wherein said joining portion comprises a folded portion, formed on said end portion of said inner frame portion, which is folded back toward said inside of said inner frame portion and overlaps part of said joining portion.

9. The vehicle door sash according to claim 7, wherein said end of said joining portion is in noncontact with said end portion of said glass run channel.

10. The vehicle door sash according to claim 1, wherein said joining portion comprises a plurality of joining portions which are formed at different positions in a lengthwise direction of said vehicle door sash.
